(19) United States
(12) Patent Application Publication
(10) Pub. No.: US 2019/0271932 A1
(43) Pub. Date: Sep. 5, 2019

(54) IMAGE FORMING DEVICE

(71) Applicant: KONICA MINOLTA, INC., Tokyo (JP)

(72) Inventors: Toshiaki TANAKA, Toyokawa-shi (JP); Masayuki WATANABE, Tokyo (JP); Masayuki FUKUNAGA, Nagareyama-shi (JP); Mineo YAMAMOTO, Tokai-shi (JP)

(73) Assignee: KONICA MINOLTA, INC., Tokyo (JP)

(21) Appl. No.: 16/278,630

(22) Filed: Feb. 18, 2019

(30) Foreign Application Priority Data
Mar. 5, 2018 (JP) 2018-038746

(51) Int. Cl. G03G 15/20

(52) U.S. Cl. CPC G03G 15/205

(57) ABSTRACT

An image forming device includes: a fixing device that includes a fixing rotary member and thermally fixes a toner image onto a recording sheet by the fixing rotary member; a temperature sensor that senses a temperature of the fixing rotary member as a fixing temperature; a driving unit that drives the fixing rotary member to rotate; a torque sensor that senses a torque value of the driving unit in a torque sensing period in which at least one of the fixing temperature and a driving speed falls within a predetermined range, the driving speed being a speed of the driving unit for driving the fixing rotary member to rotate; and a prediction unit that predicts an operating life of the fixing device based on the sensed torque value.

The entire disclosure of Japanese patent Application No. 2018-038746, filed on Mar. 5, 2018, is incorporated herein by reference in its entirety.

### BACKGROUND

### Technological Field

The present disclosure relates to image forming devices, and particularly to an art of improving accuracy of sensing torque values for use in prediction of operating life expiration of fixing devices.

### Description of the Related Art

Image forming devices employing an electronic photography system has fixing devices according to which a thermally fused toner image is pressed onto a recording sheet thereby to fix the toner image onto the recording sheet. There are various fixing methods for fixing devices. According to fixing devices employing fixing pads, for example, fixing processing is performed by feeding a recording sheet through a fixing nip that is formed by pressure-contact between a pressure roller and a fixing pad. Fixing pads have a lower heat capacity than rollers. For this reason, employment of fixing pads highly achieves energy conservation compared with the case where a fixing nip is formed by pressure-contact between a roller pair.

According to fixing devices employing fixing pads, a fixing belt rotating in a conveyance direction of a recording sheet is provided between the fixing pad and the recording sheet in order to facilitate conveyance of the recording sheet through a fixing nip. While rotating, the fixing belt slides against the fixing pad to abrade the fixing pad. This necessitates to notify a user of an advice to replace the sliding sheet 200 before the sliding sheet 200 becomes unsuitable for use due to abrasion.

In response to the necessity, Japanese Patent Application Publication No. 2007-309980 for example discloses image forming devices that monitor a torque value of a driving motor driving a fixing belt to rotate, and compares the torque value with a threshold. A frictional force generated between a fixing pad and a fixing belt increases due to abrasion of the fixing pad. A torque value of a driving motor accordingly increases. In view of this, monitoring of the torque value enables to determine whether operating life of the fixing device has expired.

In response to a print instruction, the image forming device switches its operation mode to a warm-up mode, and a fixing device accordingly starts driving a fixing belt to rotate. Simultaneously, as shown in FIG. 16, a fixing temperature rapidly increases (graph 1601). Then, the fixing temperature reaches a target temperature, and the image forming device switches the operation mode from the warm-up mode to a print mode and starts image forming processing. Each time a recording sheet enters a fixing nip, a driving speed varies by loop control (graph 1602). After the image forming processing completes, the image forming device switches to a sleep mode and stops rotation of the fixing belt and. The fixing temperature accordingly decreases to a room temperature.

Such a variation in fixing temperature and/or the driving speed causes variation in torque of the driving motor. For example as shown in FIG. 17, even while the fixing temperature is fixed around 120 degrees Celsius, the torque increases with an increase in conveyance speed of recording sheets as indicated by graph 1701. Similarly, even while the fixing temperature is fixed around 155 degrees Celsius, the torque varies with a variation in conveyance speed of recording sheets as indicated by graph 1702.

Meanwhile, even while the conveyance speed is fixed, the torque varies with a variation in fixing temperature as indicated by graphs 1711, 1712, 1713, and 1714. This is because the variation in fixing temperature causes variation in viscosity of a lubricant that is applied for reducing friction between the fixing pad and the fixing belt.

In this way, a cause other than abrasion of the fixing pad can vary the torque value of the driving motor. Thus, a method of simply monitoring the torque value such as the above conventional art might cause a risk of notifying a user of an advice to replace the fixing pad that has not yet abraded.

The similar problem also might occur in predicting operating life expiration of fixing devices employing a fixing method other than fixing pads based on at torque value.

### SUMMARY

The present disclosure was made in view of the above problem, and aims to provide an image forming device that is capable of accurately sensing operating life expiration of a fixing device.

In order to achieve the above aim, the image forming device relating to at least one aspect of the present disclosure is an image forming device comprising: a fixing device that includes a fixing rotary member and thermally fixes a toner image onto a recording sheet by the fixing rotary member; a temperature sensor that senses a temperature of the fixing rotary member as a fixing temperature; a driving unit that drives the fixing rotary member to rotate; a torque sensor that senses a torque value of the driving unit in a torque sensing period in which at least one of the fixing temperature and a driving speed falls within a predetermined range, the driving speed being a speed of the driving unit for driving the fixing rotary member to rotate; and a prediction unit that predicts an operating life of the fixing device based on the sensed torque value.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the disclosure.

In the drawings:

FIG. 1 shows major components of an image forming device relating to an embodiment of the present disclosure;

FIG. 2 shows major components of a fixing device 100;

FIG. 3 shows major components of a fixing pad 200;

FIG. 4 shows graphs explaining a relationship between a traveling distance of a fixing belt 201 and torque of a driving motor 206;

FIG. 5 is a block diagram showing major components of a controller 110;

FIG. 6 is a circuit diagram showing configuration of a torque sensor 500;

FIG. 7 is a flowchart showing notification processing of a sliding sheet 200;

FIG. 8 is a flowchart showing torque sensing processing;

FIG. 9A shows graphs explaining torque sensing periods immediately after warm-up completion, and FIG. 9B shows a graph explaining conditions for torque sensing immediately after warm-up completion;

FIG. 10A shows graphs explaining torque sensing periods during a print operation, and FIG. 10B shows graphs explaining torque sensing periods after a print operation;

FIG. 11 is a flowchart showing torque sensing processing performed during a print operation;

FIG. 12 is a flowchart showing torque sensing processing performed after a print operation;

FIG. 13 shows a graph exemplifying a temperature control ripple of a fixing temperature;

FIG. 14 shows major components of a fixing device employing a fixing roller instead of a fixing pad;

FIG. 15 is a flowchart showing torque sensing processing relating to a modification relating to the present disclosure;

FIG. 16 shows graphs exemplifying variation in fixing temperature and driving speed during image formation; and

FIG. 17 shows graphs exemplifying variation in torque due to variation in fixing temperature and driving speed.

### DETAILED DESCRIPTION OF EMBODIMENTS

Hereinafter, one or more embodiments of the present disclosure will be described with reference to the drawings. However, the scope of the invention is not limited to the disclosed embodiments.

### [1] Configuration of Image Forming Device

The following describes the configuration of an image forming device relating to the present embodiment.

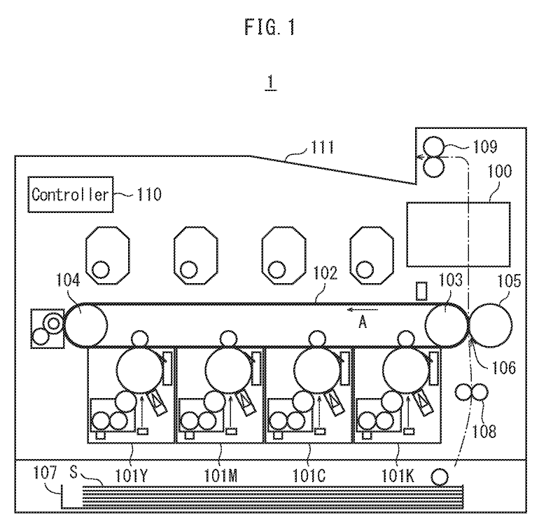

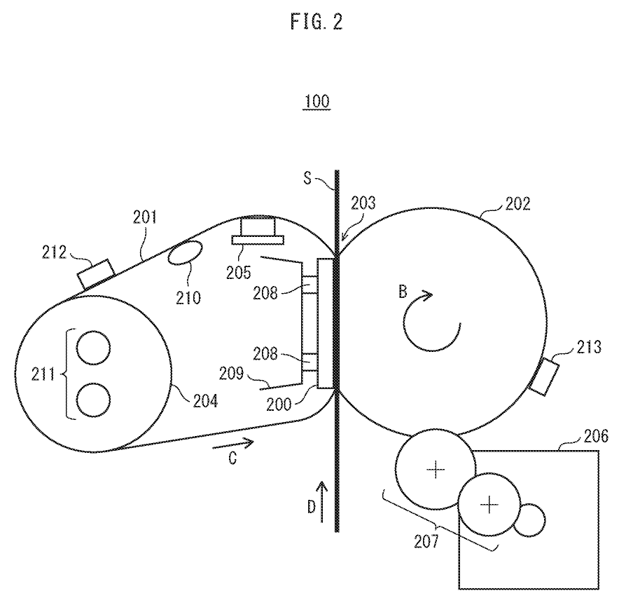

As shown in FIG. 1, an image forming device 1 is a so-called tandem type of color printer, and includes image forming units 110Y, 110M, 110C, and 110K that respectively form yellow (Y), magenta (M), cyan (C), and black (K) toner images. The formed toner images are electrostatically transferred successively onto an outer circumferential surface of an intermediate transfer belt 102 such that the toner images overlap one another. As a result, a color toner image is formed. The intermediate transfer belt 102 is an endless belt, and rotates to run in a direction indicated by an arrow A while being tensioned by a driving roller 103 and a driven roller 104.

A secondary transfer roller 105 is in pressure-contact with the driving roller 103 with the intermediate transfer belt 102 therebetween, and thus forms a secondary transfer nip 106. In accordance with a timing at which the intermediate transfer belt 102 conveys the color toner image to the secondary transfer nip 106, recording sheets S are picked up piece by piece from a paper cassette 107. A front edge of the recording sheet S comes to a pair of timing rollers 108 under suspension. This forms a loop for skew correction

Then, in accordance with a timing of a secondary transfer, the timing rollers 108 starts conveying the recording sheet S. The recording sheets S is conveyed to the secondary transfer nip 106. In the secondary transfer nip 106, the color toner image carried on the intermediate transfer belt 102 is electrostatically transferred onto the recording sheet S. Then, the recording sheet S having the color toner image electrostatically transferred thereon is further conveyed to a fixing device 100 where the color toner image is thermally fixed. The recording sheet S is then ejected by a pair of ejecting rollers 109 onto an exit tray 111.

The controller 110 is a so-called control board that controls the image forming device 1 to perform image forming processing upon receiving a print job from other device. An operation panel 112, under control by the controller 110, for example provides information to a user, an administrator, or a maintenance personnel of the image forming device 1, and receives an instruction from a user or the like.

### [2] Configuration of Fixing Device 100

The following describes the configuration of the fixing device 100.

The fixing device 100 employs fixing pads. The fixing device 100 forms a fixing nip 203 by bringing a pressure roller 202 into pressure-contact with a sliding sheet 200 with a fixing belt 201 therebetween, and feeds a recording sheet S through the fixing nip 203 thus to thermally fix a toner image onto the recording sheet S.

A specific description is given below. The fixing belt 201 is tensioned by the sliding sheet 200, a heating roller 204, and a felt 205. Upon receiving a driving force from a driving motor 206 via transmission gears 207, the pressure roller 202 is driven to rotate in a direction indicated by an arrow B. The fixing belt 201 is driven by the pressure roller 202 to rotate to run in a direction indicated by an arrow C.

With this configuration, the recording sheet S is conveyed in a direction indicated by an arrow D while being interposed between the fixing belt 201 and the pressure roller 202. Also, the recording sheet S is out of contact with the sliding sheet 200 due to the fixing belt 201 therbetween. This enables sheet conveyance. The sliding sheet 200 is supported by a fixing pad 209 via supporting members 208.

A lubricant 210 is in abutment with an inner circumferential surface of the fixing belt 201. Accordingly, while the fixing belt 201 rotates to run, the lubricant 210 is applied onto the inner circumferential surface of the fixing belt 201. The felt 205 adjusts an amount of the lubricant 210 to be applied onto the inner circumferential surface of the fixing belt 201. This application of the lubricant 210 facilitates sliding between the sliding sheet 200 and the fixing belt 201. Note that a frictional force generated between the sliding sheet 200 and the fixing belt 201 acts as a torque of the driving motor 206 via the pressure roller 202 and the transmission gears 207.

The heating roller 204 is circular cylindrical, and has a fixing heater 211 provided therein. The fixing heater 211 generates heat, and the heating roller 204 accordingly rises in temperature. This heats the fixing belt 201. When coming into pressure-contact with the recording sheet S at the fixing nip 203, the fixing belt 201, which is heated, fuses a toner image on the recording sheet S. The fused toner image is pressed onto the recording sheet S by the pressure roller 202 which is in pressure-contact with the fixing belt 201.

Note that the fixing device 100 includes temperature sensors 212 and 213. The temperature sensor 212 is provided near the fixing heater 211 of the fixing belt 201 to sense the temperature of the fixing belt 201. The temperature sensor 213 is of a contact temperature sensor that is in contact with the pressure roller 202 to sense the temperature of the pressure roller 202.

### [3] Temporal Variation of Torque of Driving Motor 206

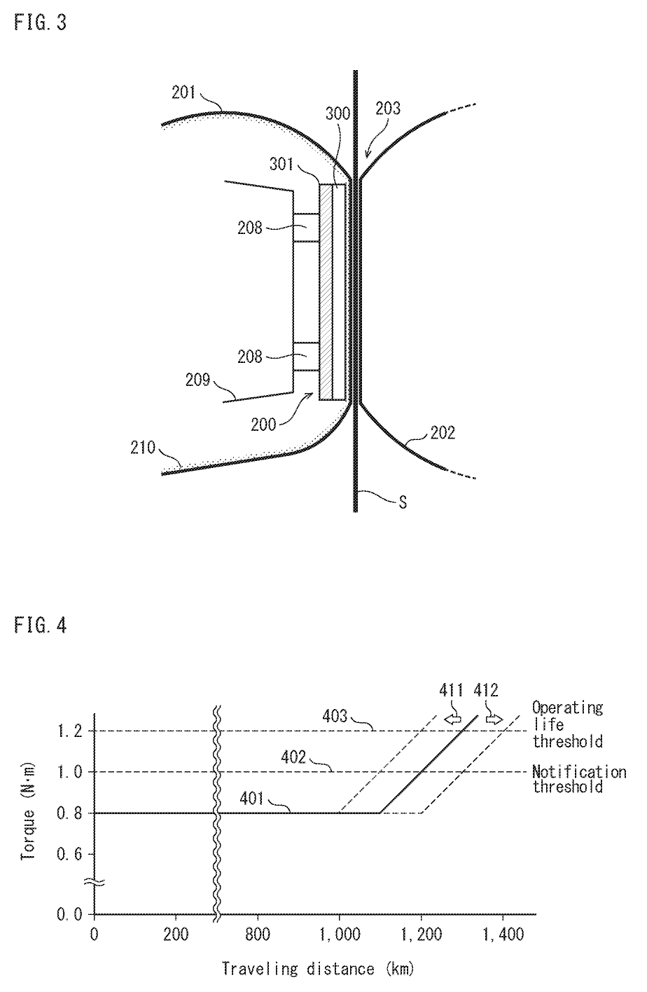

As shown in FIG. 3, the sliding sheet 200 is made of a fiberglass material 301 to which a fluorine coating 300 has been applied. The fluorine coating 300 slides against the fixing belt 201. The lubricant 210 is provided between the fluorine coating 300 and the fixing belt 201, and accordingly reduces friction between the fluorine coating 300 and the fixing belt 201.

The fluorine coating 300 gradually abrades due to friction with the fixing belt 201, and finally peels away little by little. After the fluorine coating 300 has completely peeled off, the fiberglass material 301 directly slides against the fixing belt 201. Thus, a greater frictional force is generated between the fiberglass material 301 and the fixing belt 201 than that between the fluorine coating 300 and the fixing belt 201. As a result, the torque of the driving motor 206 is greater by friction between the fiberglass material 301 and the fixing belt 201 than by friction between the fluorine coating 300 and the fixing belt 201.

As shown in FIG. 4, until the fiberglass material 301 starts being exposed due to abrasion of fluorine coating 300, the torque of the driving motor 206 is almost constant (0.8 N·m in an example of FIG. 4). When a traveling distance of the fixing belt 201 reaches 1,000 km, the fiberglass material 301 starts being exposed due to abrasion of fluorine coating 300, and accordingly the torque of the driving motor 206 starts increasing (graph 401). Then, when the torque of the driving motor 206 reaches an operating life threshold 403, replacement of the sliding sheet 200 becomes necessary.

Specifically, it is necessary to replace the sliding sheet 200 before the torque value of the fixing motor 206 reaches the operating life threshold 403, that is, before the image forming device 1 becomes unavailable. An effective method of achieving this end is to, when the torque value of the fixing motor 206 reaches a notification threshold 402 that is a torque value smaller than the operating life threshold 403, notify the necessity of replacing the sliding sheet 200 to a user or the like of the image forming device 1.

The torque of the driving motor 206 increases at a different timing (corresponding to the traveling distance of the fixing belt 201) that depends on the condition of use, such as the number of prints and the sheet feeding length per print job. For example, a smaller number of prints and/or a larger number of sheets with short feeding length per print job increases the number of times of increasing and decreasing a rotation speed of the fixing belt 201. This causes an early abrasion of the sliding sheet 200 and thus a decrease in operating life (arrow 411).

In contrast, a larger number of prints and/or a larger number of sheets with long feeding length per print job decreases the number of times of increasing and decreasing the rotation speed of the fixing belt 201. This increases the operating life of the sliding sheet 200 (arrow 412). In view of this, since it is difficult to predict the operating life of the sliding sheet 200 based on the traveling distance of the fixing belt 201, the torque value of the driving motor 206 needs to be monitored to improve the accuracy of predicting the operating life.

### [4] Configuration of Controller 110

The following describes the configuration of the controller 110.

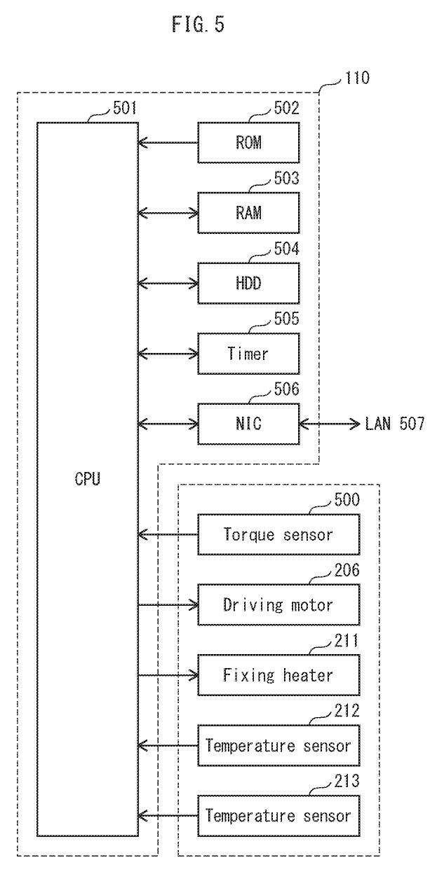

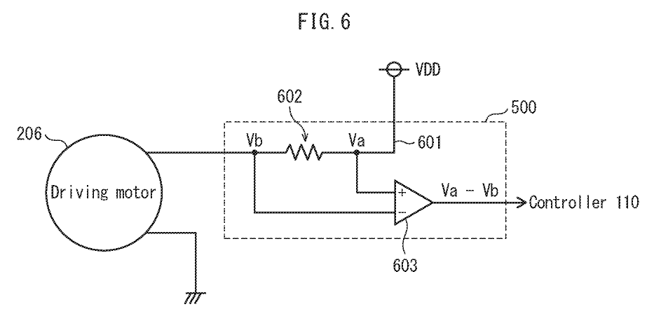

As shown in FIG. 5, the controller 110 includes a central processing unit (CPU) 501, a read only memory (ROM) 502, a random access memory (RAM) 503, and so on. Upon power-on of the image forming device 1, the CPU 501 reads a boot program from the ROM 502 for start-up, and executes an operating system (OS), a control program, and so on read from a hard disk drive (HDD) 504 with use of the RAM 503 as a storage region for work.

The CPU 501 acquires a current time with reference to a timer 505. Also, the CPU 501 accesses a local area network (LAN) 507 via a network interface card (NIC) 506 thereby to receive a print job from other device connected to the LAN 507 such as a personal computer (PC).

The controller 110 refers to a torque value of the driving motor 206 sensed by a torque sensor 500. In the case where the driving motor 206 is a DC brushless motor that consumes electric current corresponding to torque, the torque sensor 500 senses the torque of the driving motor 206 with use of the electric current supplied to the driving motor 206, as shown in FIG. 6.

Specific description is given below. Resistance elements 602 for electric current sensing are connected in series on an electric current path 601 flowing from a power source VDD to the driving motor 206, and both ends of the resistance elements 602 are connected to a differential amplifier 603. The differential amplifier 603 outputs to the controller 110 a differential voltage Va−Vb between the both ends of the resistance elements 602. The differential voltage Va−Vb between the both ends of the resistance elements 602 is proportional to an amount of the electric current supplied to the driving motor 206. This enables the controller 110 to refer to the differential voltage Va−Vb thereby to sense the torque of the driving motor 206.

Also, the controller 110 controls the driving motor 206 to drive at a driving speed falling within a speed range suitable for thermal fixing of toner images, thereby to rotate the pressure roller 202 and control the pressure roller 202 to drive the fixing belt 201 to rotate. The controller 110 controls the fixing heater 211 to turn on and off with reference to the temperature sensed by the temperature sensor 212 such that the fixing temperature falls within a temperature range suitable for thermal fixing of toner images. Note that the fixing temperature is the temperature of the fixing belt 201.

### [5] Operating Life Expiration Notification Processing of Sliding Sheet 200

The following describes operating life expiration notification processing of the sliding sheet 200.

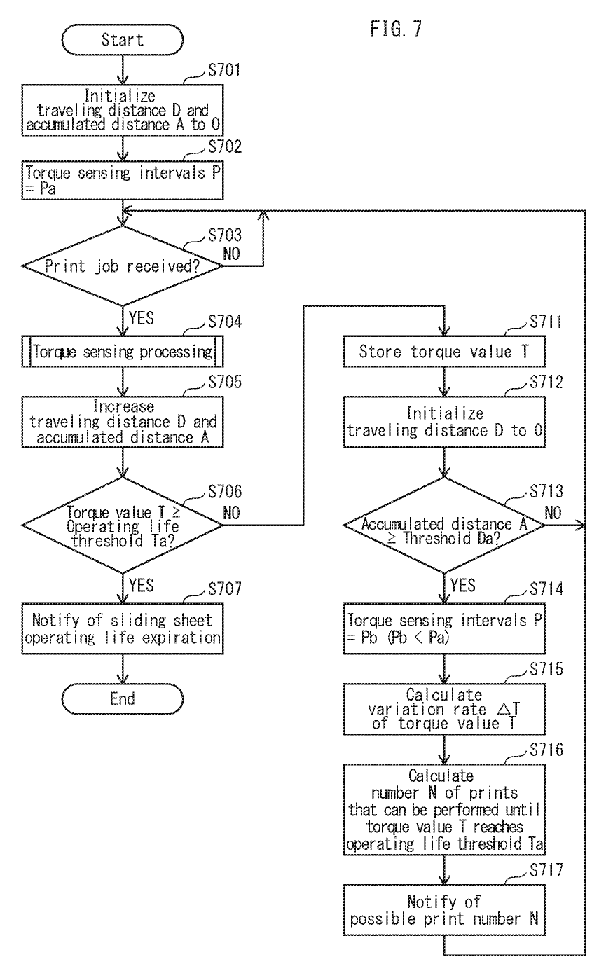

The controller 110 stores, in the HDD 504, a traveling distance D of the fixing belt 201, an accumulated distance A representing an accumulated value of the traveling distance D, and torque sensing intervals P. The controller 110 senses the torque of the driving motor 206 at the torque sensing intervals P of the traveling distances D. According to this configuration, as shown in FIG. 7, the controller 110 initializes the traveling distance D and the accumulated distance A to zero (S701) and the torque sensing intervals P to Pa (S702) at shipment from factories.

Instead of the pair of the traveling distance D and the accumulated distance A, the following pairs may be used such as a pair of a running period and an accumulated running period of the fixing belt 201 and a pair of the number of prints and an accumulated number of prints in the image forming device 1.

Then, upon receiving a print job (S703: YES), the controller 110 performs torque sensing processing (S704), and then increases the traveling distance D and the accumulated distance A by a distance the fixing belt 201 has travelled in image formation of the print job (S705). When a sensed torque value T has reached an operating life threshold Ta (S706: YES), the sliding sheet 200 is regarded as having become unsuitable for use due to abrasion. Accordingly, the controller 110 notifies operating life expiration of the sliding sheet 200 to for example the user of the image forming device 1 via the operation panel 112 (S707), and ends the processing.

When the sensed torque value T has not yet reached the operating life threshold Ta (S706: NO), the controller 110 stores the sensed torque value T in the HDD 504 together with the accumulated distance A (S711), and initializes the traveling distance D to zero (S712). Until the accumulated distance A reaches a threshold Da (S713: NO), the flow returns to Step 5703 for repetition of the above processing.

When the accumulated distance A reaches the threshold Da (S713: YES), the controller 110 changes the torque sensing intervals P from the initial value Pa to a smaller value Pb (S714). This configuration increases a frequency of sensing the torque value of the driving motor 206. Accordingly, it is, for example, possible to stop image formation when the torque value reaches the operating life threshold Ta, thereby to avoid the fixing belt 201 from wearing out due to friction with the fiberglass material 301 of the fixing pad 200.

Next, the controller 110 calculates a variation rate ΔT of the torque value T (S715). In the present embodiment, the variation rate ΔT is calculated from the following equation (1) with use of a torque value Tprev and an accumulated distance Aprev that have been previously stored and a currently sensed torque value Tnow and a current accumulated distance Anow.

ΔT=(Tnow−Tprev)/(Anow−Aprev) (1)

The controller 110 calculates the possible print number N with use of the variation rate ΔT (S716). The possible print number N indicates the number of prints that can be performed until the torque value T reaches the operating life threshold Ta. First, a possible traveling distance Dr is calculated from the following equation (2). The possible traveling distance Dr is a possible distance the fixing belt 201 can travel until the torque value T reaches the operating life threshold Ta.

Dr=(Ta−Tnow)/ΔT (2)

The number of possible prints N is calculated from the following equation (3) with use of a coefficient C for converting the possible traveling distance Dr of the fixing belt 201 into the number N of possible prints such as the number of prints that can be performed on only A4-size sheets.

N=C×Dr (3)

The controller 110 displays the number N of possible prints, which is calculated in this manner, on the display panel 112 (S717) thereby to notify the necessity for replacing the sliding sheet 200 in the near future to the user of the image forming device 1 or the like. Then, the flow returns to Step S703 for repetition of the above processing.

### [6] Processing (S706) of Sensing Torque of Driving Motor 206

The following describes the processing (S706) of sensing the torque of the driving motor 206.

The torque of the driving motor 206 can vary depending on the fixing temperature, the system speed, and the like as described above. Due to this, it is necessary to sense the torque of the driving motor 206 under certain conditions to accurately determine operating life expiration of the sliding sheet 200.

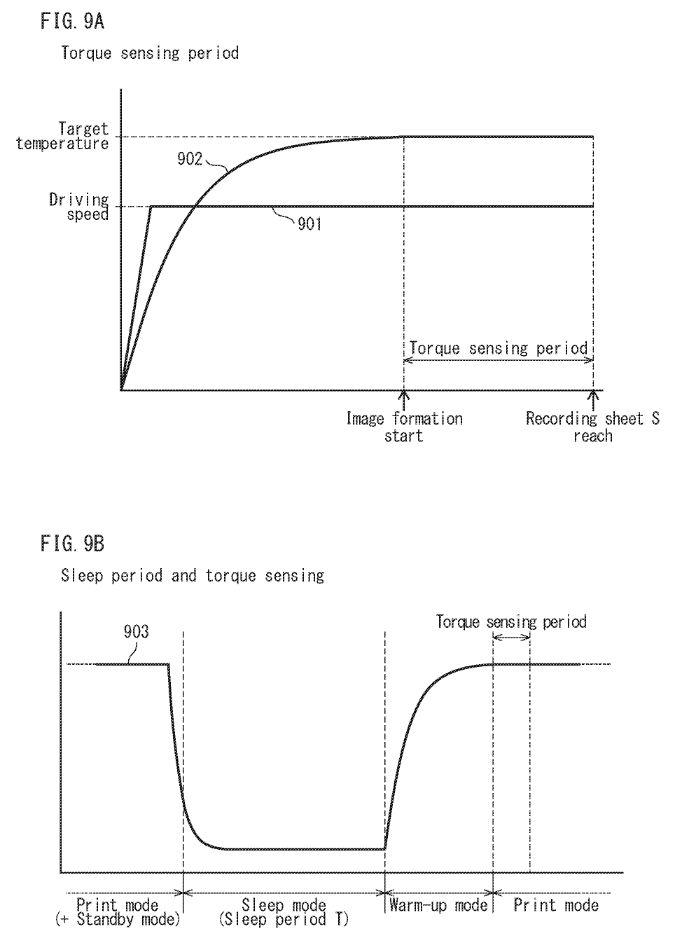

Both the fixing temperature and the driving speed of the driving motor 206 seem to be constant in a period from when image formation starts after the fixing temperature has reached the target temperature by warm-up to when a recording sheet S reaches the fixing device 100. In this period, the driving motor 206 drives at a constant driving speed (graph 901 in FIG. 9A) to uniformly increase the temperature of the fixing belt 201. After reaching the target temperature, the fixing temperature is maintained at the target temperature (graph 902 in FIG. 9A). Also, in this period, no recording sheet S enters the fixing nip 203, and thus the torque varies only due to abrasion of the sliding sheet 200.

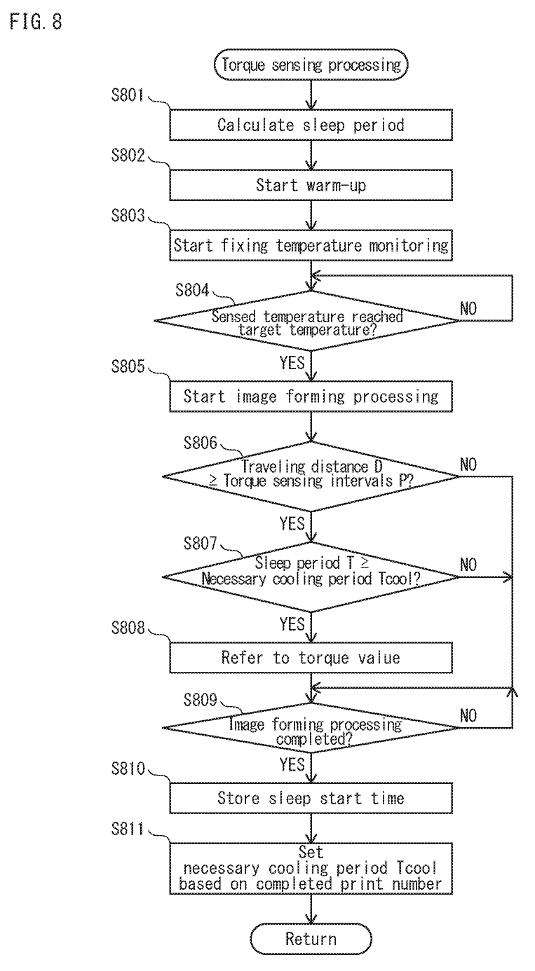

The following describes processing of sensing the torque of the driving motor 206 immediately after the warm-up completes. As shown in FIG. 8, in the torque sensing processing (S706), the controller 110 firstly switches an operating mode of the image forming device 1 from a sleep mode to a warm-up mode, and calculates a sleep period (S801).

In the present embodiment, a sleep period T is calculated with use of a current time and a sleep start time that is stored in the HDD 504 (FIG. 9B). The sleep start time is a time when the operating mode has switched to the sleep mode. The controller 110 starts warm-up (S802), and starts monitoring the fixing temperature (S803). Specifically, the controller 110 repeatedly refers to the temperature sensed by the temperature sensor 212 to determine whether the sensed temperature has reached the target temperature.

Determination as to whether the sensed temperature has reached the target temperature may be made by determining whether the sensed temperature falls within a predetermined temperature range having the target temperature as the middle value such as a range ±5 degrees Celsius relative to the target temperature, in consideration of the sensing accuracy by the temperature sensor 212. When the sensed temperature has reached the target temperature (S804: YES), the controller 110 switches the operating mode of the image forming device 1 from the warm-up mode to the print mode, and controls the image forming device 1 to start image forming processing (S805).

When the traveling distance D of the fixing belt 201 is less than the torque sensing intervals P (S806: NO), the controller 110 does not perform torque sensing, and the flow proceeds to Step S809. When the traveling distance D has reached the torque sensing intervals P (S806: YES), the controller 110 performs next processing (S807) for torque sensing.

The pressure roller 202 thermally expands with an increase in its internal temperature, and accordingly is brought into pressure-contact with the fixing belt 201 by a greater force. This increases the torque of the driving motor 206. Due to this, it is necessary to sense the torque of the driving motor 206 at a constant internal temperature of the pressure roller 202 so as to sense variation in the torque only due to abrasion of the sliding sheet 200.

In the following, specific description is given on torque sensing at a constant temperature. A short sleep period after completion of image forming processing increases the internal temperature of the pressure roller 202. In contrast, a sufficiently long sleep period decreases the internal temperature of the pressure roller 202 to a sufficiently low value. This decreases the increase in torque of the driving motor 206, which is caused by thermal expansion of the pressure roller 202, to a negligible level. Thus, when the sleep period T is equal to or longer than a necessary cooling period Tcool that is necessary for sufficiently cooling the pressure roller 202 (S807: YES), the controller 110 refers to a torque value sensed by the torque sensor 500 (S808).

Note that torque sensing in Step 5808 needs to be completed before the recording sheet S reaches the fixing nip 203. This is because the entry of the recording sheet S into the fixing nip 203 necessarily increases the torque of the driving motor 206. The recording sheet S reaches the fixing nip 203 after a predetermined period has elapsed since the timing rollers 108 started conveying the recording sheet S. The predetermined period is calculated by dividing the length of a conveyance path for recording sheets S from the timing rollers 108 to the fixing device 100 by the system speed.

When the image forming processing designated in the print job completes (S809: YES), the controller 110 stores the current time as the sleep start time in the HDD 504 (S810), and sets the necessary cooling period Tcool based on the number of completed prints in the print job (S811). Alternatively, the necessary cooling period Tcool may be set based on a period necessary for print instead of the number of completed prints. The same applies to subsequent description. Then, the controller 110 switches the operating mode of the image forming device 1 from the print mode to the sleep mode. The flow returns to Step S801 for repetition of the above processing.

In the case where the number of completed prints is a predetermined number or smaller, the larger number of completed prints increases the internal temperature of the pressure roller 202, and thus increases the necessary cooling period Tcool. The internal temperature of the pressure roller 202 does not increase without limit. When the number of completed prints exceeds the predetermined number, the internal temperature of the pressure roller 202 reaches its maximum value, and thus the necessary cooling period Tcool reaches its maximum value. The predetermined number of completed prints is set by experiments, simulations, or the like.

This configuration avoids torque variation due to any cause other than abrasion of the sliding sheet 200, thereby to accurately sense the torque variation only due to abrasion of the sliding sheet 200.

After switching from the print mode to the standby mode, the operating mode of the image forming device 1 sometimes switches to the sleep mode. In the standby mode, the fixing temperature is maintained at the target temperature. This is in order to omit warm-up for a subsequent print job to reduce a period necessary to start image forming processing. Accordingly, the pressure roller 202 has the internal temperature that is maintained high in the standby mode as well as in the print mode. In view of this, the necessary cooling period Tcool may be set based on, instead of the number of completed prints, a period in which the fixing belt 201 is maintained at the target temperature.

### [7] Modifications

Although the present disclosure has been explained based on the above embodiment, the present disclosure is not of course limited to the above embodiment. The present disclosure may include the following modifications.

(7-1) In the above embodiment, the description has been given with use of the example in which the torque of the driving motor 206 is sensed immediately after warm-up completion. However, the present disclosure is of course not limited to this, and alternatively the following modification is possible.

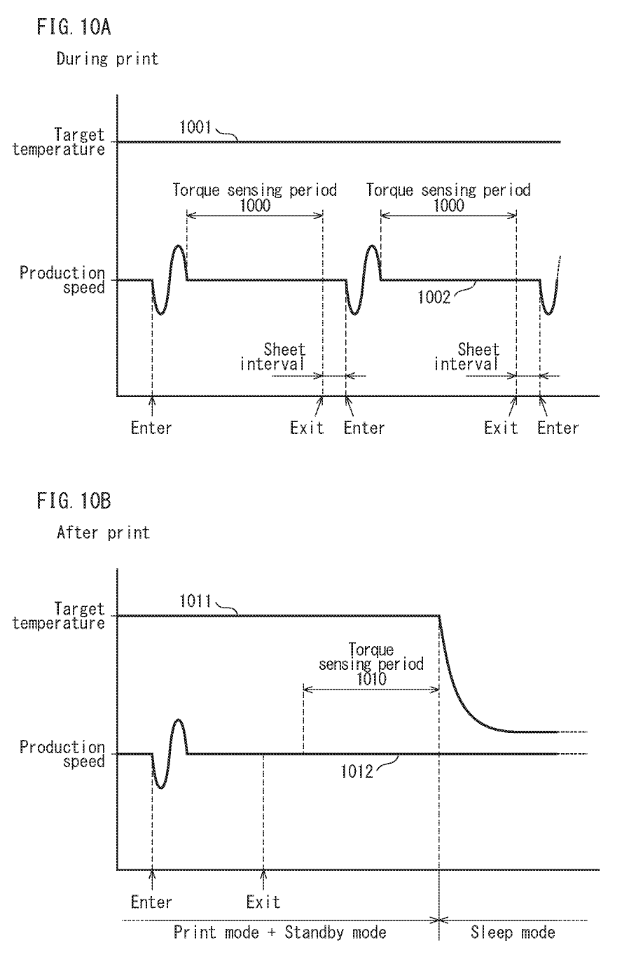

For example, as shown in FIG. 10A, the fixing temperature is maintained almost at the target temperature during a print (graph 1001). Also, the driving speed of the driving motor 206, which is under the loop-control so as to be maintained at a production speed (target speed), is maintained almost at a constant production speed in torque sensing periods 1000 (graph 1002). The torque sensing periods 1000 are each a period excluding: (i) a period in which the driving speed varies due to the front edge of a recording sheet S entering the fixing nip 203; (ii) a period in which the driving speed varies due to the rear edge of the recording sheet S exiting from the fixing nip 203; and (iii) sheet intervals.

Specifically, the torque sensing period 1000 starts after an elapse of a predetermined period, from when the front edge of a recording sheet S enters the fixing nip 203 to when the driving speed of the driving motor 206 returns to the production speed. Then, the torque sensing period 1000 ends when the rear edge of the recording sheet S exits from the fixing nip 203.

The timing when the front edge of the recording sheet S enters the fixing nip 203 is calculated based on the timing when the timing rollers 108 starts conveying the recording sheet S. Also, the time when the rear edge of the recording sheet S exits from the fixing nip 203 is calculated based on the driving speed of driving the fixing belt 201 and the size of the recording sheet S in the conveyance direction. The timing when the torque sensing period 1000 starts is calculated based on the timing when the timing rollers 108 starts conveying the recording sheet S.

Further, taking into consideration variation of the torque of the driving motor 206 due to variation in internal temperature of the pressure roller 202, torque sensing is performed only when the sleep time T has is equal to or longer than the necessary cooling period Tcool, in the similar manner to the above embodiment. Moreover, the internal temperature of the pressure roller 202 increases due to consecutive sheet feeding, and accordingly the torque value of the driving motor 206 can vary depending on the order of the recording sheet S in the consecutive sheet feeding. In the present modification, torque sensing of the driving motor 206 is performed while an initial recording sheet S is fed in each sheet feeding. This configuration maximizes the number of times for torque sensing, as image formation always has the initial recording sheet.

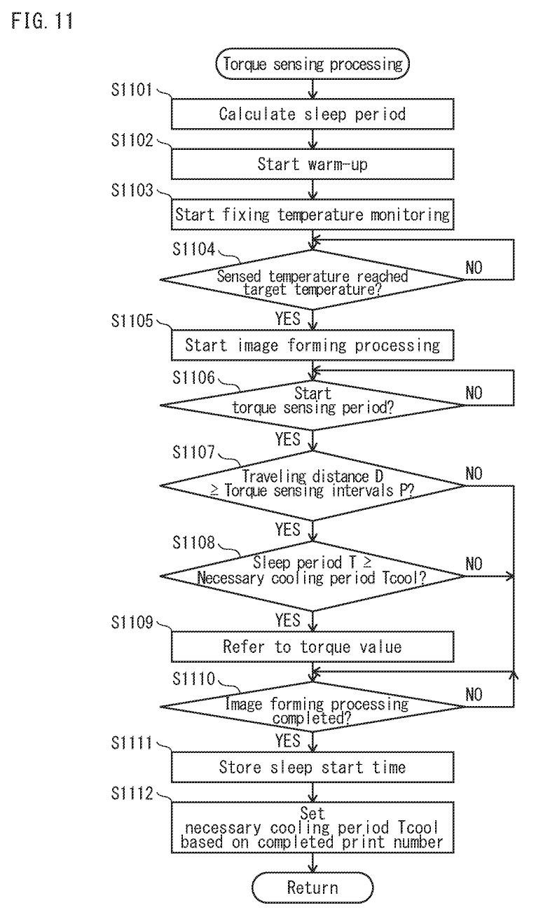

FIG. 11 is a flowchart showing torque sensing processing relating to the present modification. The flowchart in FIG. 11 differs from the flowchart in FIG. 8 in additionally including Step S1106. The flowchart in FIG. 11 has Steps S1101 to S1105 and Steps S1107 to S1112 that are respectively equal to Steps S801 to S805 and Steps S806 to S811 in the flowchart in FIG. 8.

In Step S1106 in FIG. 11, determination is performed as to whether the timing has come to start the torque sensing period 1000. In the present modification, since torque sensing is performed while the initial recording sheet S is fed, this determination is performed by determining whether the predetermined period has elapsed after the timing rollers 108 started conveying the initial recording sheet S. In general, to perform torque sensing while an n-th recording sheet S is fed, the determination may be performed by determining whether the predetermined period has elapsed after the timing rollers 108 started conveying the n-th recording sheet S.

As above, even in the torque sensing period 1000, in which both the fixing temperature and the driving speed are constant, it is possible to accurately perform torque sensing of the driving motor 206. Note that in the case where the sheet intervals are long enough to have a period in which both the fixing temperature and the driving speed are constant, torque sensing may be performed during this period. In this case, the number of prints per print job needs to be at least two.

Furthermore, torque sensing of the driving motor 206 may be performed during a torque sensing period 1010 as shown in FIG. 10B. Specifically, after the rear edge of a recording sheet S as the last page designated in a print job exits from the fixing nip 203, the torque sensing period 1010 starts when the driving speed becomes stable at the production speed and ends when the operating mode of the image forming device 1 switches to the sleep mode. Even in this torque sensing period 1010, both the fixing temperature and the driving speed are constant, and thus it is possible to accurately perform torque sensing of the driving motor 206.

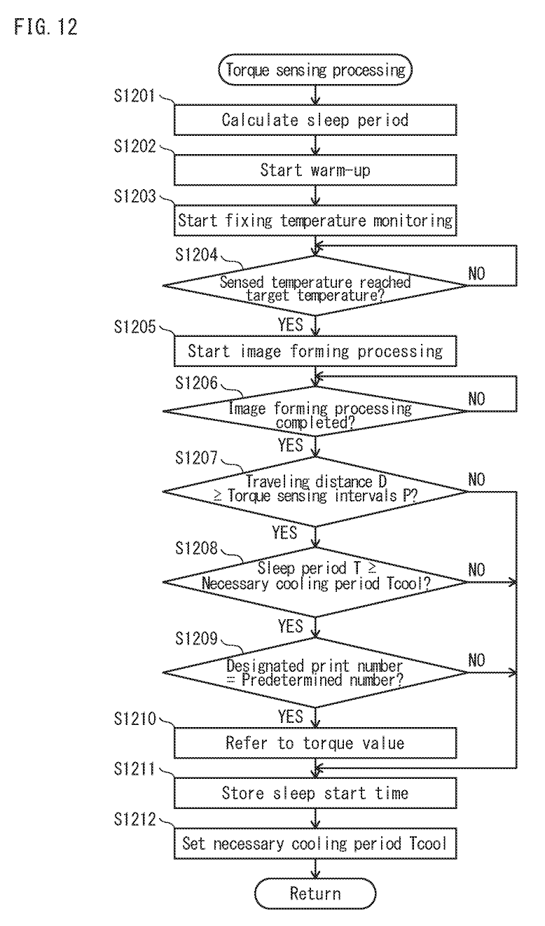

FIG. 12 is a flowchart showing torque sensing processing relating to the present modification. The flowchart in FIG. 12 differs from the flowchart in FIG. 8 in including Steps S1206 to S1210 instead of Steps S806 to S809. The flowchart in FIG. 12 has Steps S1201 to S1205 and Steps S1211 to S1212 that are respectively equal to Steps S801 to S805 and Steps S810 to S811 in the flowchart in FIG. 8.

In Step S1206 in FIG. 12, determination is performed as to whether image forming processing is complete. When the image forming processing is complete (S1206: YES), the controller 110 compares the traveling distance D of the fixing belt 201 with the torque sensing intervals P. When the traveling distance D of the fixing belt 201 has not yet reached the torque sensing intervals P (S1207: NO), the controller 110 does not perform torque sensing, and the flow proceeds to Step S1211.

When the traveling distance D has reached the torque sensing intervals P (S1207: YES), the controller 110 compares the last sleep period T with the necessary cooling period Tcool. When the sleep period T is equal to or longer than the necessary cooling period Tcool (S1208: YES), the controller 110 checks whether the number of prints designated in a print job is a predetermined number such as one.

When the number of designated prints is the predetermined number (S1209: YES), the controller 110 performs torque sensing (S1210). This torque sensing is performed before the operating mode of the image forming device 1 switches to the sleep mode.

(7-2) In the above embodiment, the description has been given with use of the example in which whether to perform torque sensing is determined in consideration of thermal expansion of the pressure roller 202. However, the present disclosure is of course not limited to this, and alternatively the following modification is possible. In the case where the pressure roller 202 has a small coefficient of thermal expansion to an extent that an influence on the torque of the driving motor 206 is negligible, torque sensing may be performed irrespective of the number of prints designated in a print job.

(7-3) In the above embodiment, the description has been given with use of the example in the case where the fixing temperature falls within the predetermined temperature range having the target temperature as the middle value, the fixing temperature is regarded as being constant and thus torque sensing is performed. However, the present disclosure is of course not limited to this, and alternatively the following modification is possible.

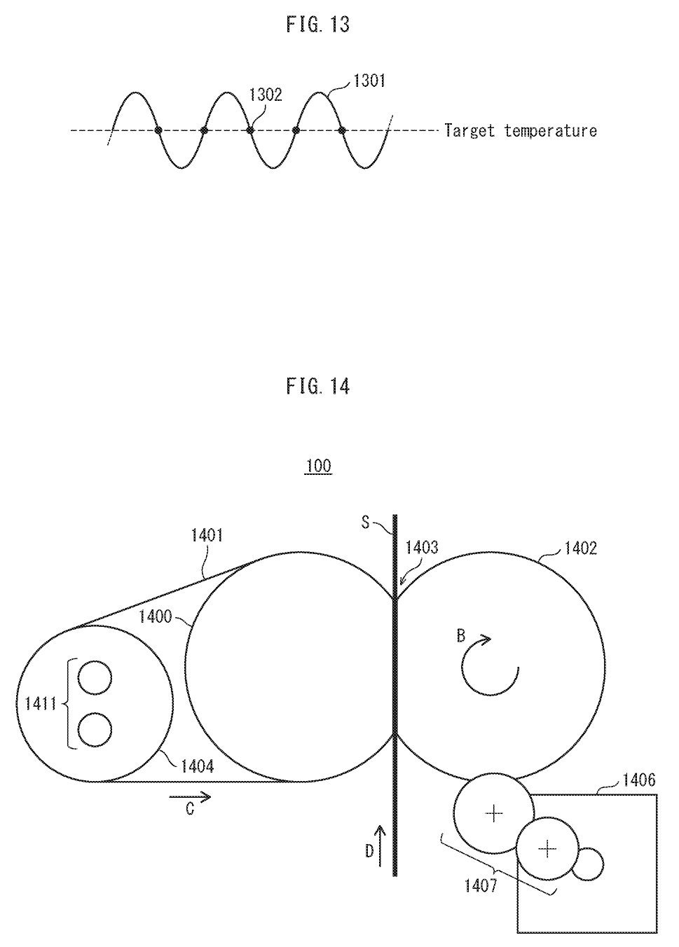

According to typical image forming devices, loop-control is performed in accordance with the difference between the fixing temperature and the target temperature to maintain the fixing temperature at the target temperature. Owing to this configuration, as shown in FIG. 13, an actual value 1301 of the fixing temperature does not always coincide with the target temperature, and ripples due to temperature control is observed. In FIG. 13, solid circles 1302 each represent a timing when the actual value 1301 coincides with the target temperature. By performing torque sensing at these timings, it is possible to further exclude the influence that temperature variation has on the torque value. This configuration enables to further accurately sense torque variation due to abrasion of the sliding sheet 200.

(7-4) In the above embodiment, the description has been given with use of the example in which the fixing device 100 employs fixing pads. However, the present disclosure is of course not limited to this, and may be applied to fixing devices not employing fixing pads. For example as shown in FIG. 14, a fixing device 100 employs a fixing roller 1400 instead of a fixing pad, and has a driving motor 1406 whose torque varies due to abrasion of a fixing belt 1401. Application of the present disclosure enables to accurately sense torque with respect to fixing devices not employing fixing pads, and thus to accurately predict operating life expiration of such fixing devices.

(7-5) In the above embodiment, the description has been given with use of the example in which since the internal temperature of the pressure roller 202 influences the torque value, determination is performed as to whether to perform torque sensing by determining whether the sleep period T has reached the necessary cooling period Tcool. However, the present disclosure is of course not limited to this, and alternatively the following modification is possible.

The internal temperature of the pressure roller 202 can decrease at a speed different depending on an internal temperature of the image forming device 1. A high internal temperature of the image forming device 1 indicates that the internal temperature of the pressure roller 202 might not have been sufficiently decreased even after the sleep period has reached the necessary cooling period Tcool. In contrast, a low internal temperature of the image forming device 1 indicates that the internal temperature of the pressure roller 202 excessively decreases before the sleep period reaches the necessary cooling period Tcool, and thus the torque of the driving motor 206 might become excessively small.

On the other hand, it is regarded that in the case where the internal temperature of the image forming device 1 falls within a predetermined temperature range, the internal temperature of the pressure roller 202 accordingly falls within a predetermined temperature range. In view of this, the image forming device 1 relating to the present modification additionally includes a temperature sensor for sensing the internal temperature of the image forming device 1, and performs torque sensing only when the internal temperature of the image forming device 1 falls within the predetermined temperature range. In other words, torque sensing is prohibited when the internal temperature of the image forming device 1 falls out of the predetermined temperature range.

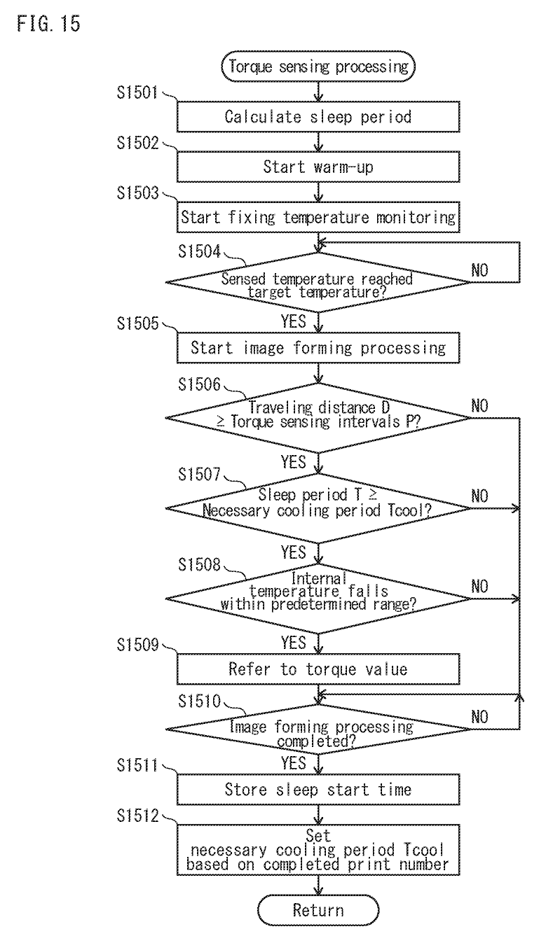

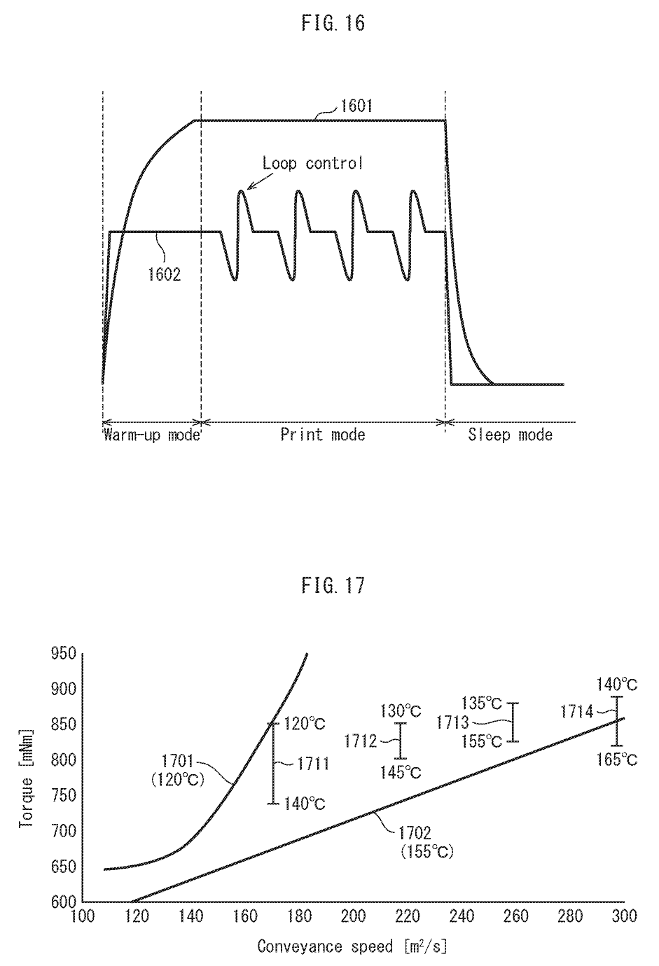

A flowchart in FIG. 15 corresponds to the flowchart in FIG. 8. The flowchart in FIG. 15 has Steps S1501 to S1507 and Steps S1509 to S1512 that are respectively equal to Steps S801 to S807 and Steps S808 to S811 in the flowchart in FIG. 8. The flowchart in FIG. 15 differs from the flowchart in FIG. 8 in including Step S1508 in which when the internal temperature of the image forming device 1 falls out of the predetermined temperature range (S1508: NO), torque sensing (S1509) is not performed.

This configuration enables to exclude the influence that variation in internal temperature of the image forming device 1 has on torque variation, thereby to further accurately predict operating life expiration of the sliding sheet 200.

(7-6) In the above embodiment, the description has been given with use of the example in which the internal temperature of the pressure roller 202 is evaluated by determining whether the sleep period T has reached the necessary cooling period Tcool. However, the present disclosure is of course not limited to this, and alternatively the following modification is possible.

The image forming device 1 relating to the present modification additionally includes a temperature sensor for sensing the internal temperature of the image forming device 1. At the start of warm-up, the controller 110 senses the surface temperature of the pressure roller 202 with use of the temperature sensor 213. The controller 110 may perform torque sensing of the driving motor 206 only when the surface temperature of the pressure roller 202 differs from the internal temperature of the image forming device 1 by a predetermined value or smaller, in other words, only when the surface temperature of the pressure roller 202 falls within a predetermined temperature range having the internal temperature of the image forming device 1 as the middle value. This configuration also enables to improve the accuracy of torque sensing.

(7-7) In the above embodiment, the description has been given with use of the example in which torque sensing is performed during a print operation. However, the present disclosure is of course not limited to this, and alternatively torque sensing may be performed in a test mode that is executed as an interrupt during image formation.

In the test mode, no recording sheet S is fed to the fixing device 100, and accordingly the driving speed of driving the fixing belt 201 is stable. Also, in the test mode, which interrupts the print operation, the fixing temperature is controlled at a predetermined target temperature. Thus, by performing torque sensing while maintaining both the fixing temperature and the driving speed at respective constant values in the test mode, it is possible to improve the accuracy of torque sensing.

(7-8) In the above embodiment, the description has been given with use of the example in which the controller 110 performs torque sensing during a period in which the controller 110 controls the driving motor 206 such that the driving speed falls within a speed range suitable for thermal fixing of toner images, and controls the fixing heater 211 to turn on and off such that the fixing temperature falls within a temperature range suitable for thermal fixing of toner images. Alternatively, the following modification is possible. The speed range and/or the temperature range described above differs depending on the sheet type of recording sheets S, whether toner images are of colored ones or monochrome ones, and so on. In view of this, torque sensing may be performed only when specific toner images are thermally fixed onto recording sheets S of a specific sheet type, that is, only under constant conditions. In this case, it is preferable that the conditions should be that toner images that are of frequently used type are formed on recording sheets of frequently used type. For example in the case where monochrome images are frequently formed on plain papers, torque sensing may be performed only in this case.

(7-9) In the above embodiment, the description has been given with use of the example in which torque sensing is performed when the driving speed and the fixing temperature each fall within a predetermined range. However, the present disclosure is of course not limited to this. Alternatively, in the case where the torque value is difficult to vary even with variation in driving speed depending on the configurations of the image forming device 1 and the fixing device 100, torque sensing may be performed during a period in which the fixing temperature is constant irrespective of the driving speed. In contrast, in the case where the torque value is difficult to vary even with variation in fixing temperature, torque sensing may be performed during a period in which the driving speed is constant irrespective of the fixing temperature. Both the cases also improve the accuracy of torque sensing.

(7-10) In the above embodiment, the description has been given with use of the example in which the image forming device 1 is a tandem-type color printer. However, the present disclosure is of course not limited to this, and may be applied to color printers of other tandem type or monochrome printers. Further, the effects of the present disclosure can be achieved when the present disclosure is applied to single function peripherals (SFPs) such as copying devices incorporating a scanner and facsimile devices incorporating a facsimile communication function, or multi-function peripherals (MEPs) incorporating several such functions.

### [8] Supplement

The image forming device according to at least one embodiment of the present disclosure is an image forming device comprising: a fixing device that includes a fixing rotary member and thermally fixes a toner image onto a recording sheet by the fixing rotary member; a temperature sensor that senses a temperature of the fixing rotary member as a fixing temperature; a driving unit that drives the fixing rotary member to rotate; a torque sensor that senses a torque value of the driving unit in a torque sensing period in which at least one of the fixing temperature and a driving speed falls within a predetermined range, the driving speed being a speed of the driving unit for driving the fixing rotary member to rotate; and a prediction unit that predicts an operating life of the fixing device based on the sensed torque value.

Also, the image forming device may further comprise: a temperature controller that controls the fixing temperature to fall within a range suitable for thermal fixing of toner images; and a speed controller that controls the driving unit such that the driving speed falls within a range suitable for thermal fixing of toner images. The torque sensing period may be a period in which the temperature controller and the speed controller respectively control the fixing temperature and the driving speed to fall within the respective predetermined ranges, except a period in which the driving speed varies due to start and end of pressure-contact between the recording sheet and the fixing rotary member.

Also, in the torque sensing period, the driving speed may be maintained constant, and the torque sensing period may start when the fixing temperature falls within the predetermined range after completion of warm-up for increasing the fixing temperature, and end when a front edge of the recording sheet reaches the fixing rotary member.

Also, the image forming device may further comprise a prohibition unit that prohibits the torque sensor from sensing the torque value when a period from completion of a print job immediately preceding the warm-up to start of the warm-up is shorter than a predetermined necessary cooling period.

Also, the image forming device may further comprise a necessary cooling period setting unit that sets the necessary cooling period based on a fixing period necessary for the last print job.

Also, the image forming device may further comprise an internal temperature sensor that senses an internal temperature of the image forming device; and a prohibition unit that prohibits the torque sensor from sensing the torque value when the internal temperature of the image forming device falls out of a predetermined range.

Also, the image forming device may further comprise a pressure rotary member that comes into pressure-contact with the fixing rotary member such that the recording sheet is thermally fused and is pressed onto the recording sheet; a pressure rotary member temperature sensor that senses a temperature of the pressure rotary member; and a prohibition unit that prohibits the torque sensor from sensing the torque value when the temperature of the pressure rotary member falls out of a predetermined range.

Also, the image forming device may further comprise an internal temperature sensor that senses an internal temperature of the image forming device. The prohibition unit may prohibit the torque sensor from sensing the torque value when the temperature of the pressure rotary member falls out of a predetermined range relative to the internal temperature of the image forming device at start of a last warm-up before the torque sensing period.

Also, the torque sensing period may start when variation of the driving speed due to a front edge of a recording sheet reaching the fixing rotary member ends, and end when a rear edge of the recording sheet exits from the fixing rotary member.

Also, the image forming device may further comprise a prohibition unit that prohibits the torque sensor from sensing the torque value when a period from start of one print job to start of the torque sensing period is longer than a predetermined maximum period.

Also, the image forming device may further comprise a maximum period setting unit that sets the maximum period based on a period from completion of a print job immediately preceding the one print job to start of warm-up for the one print job.

Also, the image forming device may further comprise a timing specification unit that specifies a torque sensing timing that is a timing when the fixing temperature coincides with a target temperature. The torque sensor may sense the torque value at the specified torque sensing timing in the torque sensing period.

Also, the torque sensing period may be a period in which the fixing temperature and the driving speed are maintained within the respective predetermined ranges after variation of the driving speed due to a rear edge of a last recording sheet in one print job exiting from the fixing rotary member ends.

Also, the torque sensing period may be a period in a test mode in which execution of a print job is interrupted, the driving speed is maintained constant, and the fixing temperature is maintained within the predetermined range.

Also, the prediction unit may predict a timing at which the torque value reaches a value corresponding to expiration of the operating life based on a timing at which the sensed torque value increases.

With the above configurations, torque sensing is performed in a period in which at least one of the fixing temperature and the driving speed of the driving unit falls within the predetermined range. This prevents decrease of the prediction of accuracy of the operating life of the fixing device due to variation in torque caused by variation in at least one of the fixing temperature and the driving speed.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image forming device comprising:
a fixing device that includes a fixing rotary member and thermally fixes a toner image onto a recording sheet by the fixing rotary member;
a temperature sensor that senses a temperature of the fixing rotary member as a fixing temperature;
a driving unit that drives the fixing rotary member to rotate;
a torque sensor that senses a torque value of the driving unit in a torque sensing period in which at least one of the fixing temperature and a driving speed falls within a predetermined range, the driving speed being a speed of the driving unit for driving the fixing rotary member to rotate; and
a prediction unit that predicts an operating life of the fixing device based on the sensed torque value.

2. The image forming device of claim 1, further comprising:
a temperature controller that controls the fixing temperature to fall within a range suitable for thermal fixing of toner images; and
a speed controller that controls the driving unit such that the driving speed falls within a range suitable for thermal fixing of toner images, wherein
the torque sensing period is a period in which the temperature controller and the speed controller respectively control the fixing temperature and the driving speed to fall within the respective predetermined ranges, except a period in which the driving speed varies due to start and end of pressure-contact between the recording sheet and the fixing rotary member.

3. The image forming device of claim 1, wherein
in the torque sensing period, the driving speed is maintained constant, and
the torque sensing period starts when the fixing temperature falls within the predetermined range after completion of warm-up for increasing the fixing temperature, and ends when a front edge of the recording sheet reaches the fixing rotary member.

4. The image forming device of claim 3, further comprising
a prohibition unit that prohibits the torque sensor from sensing the torque value when a period from completion of a print job immediately preceding the warm-up to start of the warm-up is shorter than a predetermined necessary cooling period.

5. The image forming device of claim 4, further comprising
a necessary cooling period setting unit that sets the necessary cooling period based on a fixing period necessary for the last print job.

6. The image forming device of claim 3, further comprising:
an internal temperature sensor that senses an internal temperature of the image forming device; and
a prohibition unit that prohibits the torque sensor from sensing the torque value when the internal temperature of the image forming device falls out of a predetermined range.

7. The image forming device of claim 3, further comprising:
a pressure rotary member that comes into pressure-contact with the fixing rotary member such that the recording sheet is thermally fused and is pressed onto the recording sheet;
a pressure rotary member temperature sensor that senses a temperature of the pressure rotary member; and
a prohibition unit that prohibits the torque sensor from sensing the torque value when the temperature of the pressure rotary member falls out of a predetermined range.

8. The image forming device of claim 7, further comprising
an internal temperature sensor that senses an internal temperature of the image forming device, wherein
the prohibition unit prohibits the torque sensor from sensing the torque value when the temperature of the pressure rotary member falls out of a predetermined range relative to the internal temperature of the image forming device at start of a last warm-up before the torque sensing period.

9. The image forming device of claim 1, wherein
the torque sensing period starts when variation of the driving speed due to a front edge of a recording sheet reaching the fixing rotary member ends, and ends when a rear edge of the recording sheet exits from the fixing rotary member.

10. The image forming device of claim 9, further comprising
a prohibition unit that prohibits the torque sensor from sensing the torque value when a period from start of one print job to start of the torque sensing period is longer than a predetermined maximum period.

11. The image forming device of claim 10, further comprising
a maximum period setting unit that sets the maximum period based on a period from completion of a print job immediately preceding the one print job to start of warm-up for the one print job.

12. The image forming device of claim 9, further comprising:
an internal temperature sensor that senses an internal temperature of the image forming device; and
a prohibition unit that prohibits the torque sensor from sensing the torque value when the internal temperature of the image forming device falls out of a predetermined range.

13. The image forming device of claim 9, further comprising:
a pressure rotary member that comes into pressure-contact with the fixing rotary member such that the recording sheet is thermally fused and is pressed onto the recording sheet;
a pressure rotary member temperature sensor that senses a temperature of the pressure rotary member; and
a prohibition unit that prohibits the torque sensor from sensing the torque value when the temperature of the pressure rotary member falls out of a predetermined range.

14. The image forming device of claim 13, further comprising
an internal temperature sensor that senses an internal temperature of the image forming device, wherein
the prohibition unit prohibits the torque sensor from sensing the torque value when the temperature of the pressure rotary member falls out of a predetermined range relative to the internal temperature of the image forming device at start of a last warm-up before the torque sensing period.

15. The image forming device of claim 9, further comprising
a timing specification unit that specifies a torque sensing timing that is a timing when the fixing temperature coincides with a target temperature, wherein
the torque sensor senses the torque value at the specified torque sensing timing in the torque sensing period.

16. The image forming device of claim 1, wherein
the torque sensing period is a period in which the fixing temperature and the driving speed are maintained within the respective predetermined ranges after variation of the driving speed due to a rear edge of a last recording sheet in one print job exiting from the fixing rotary member ends.

17. The image forming device of claim 16, further comprising
a prohibition unit that prohibits the torque sensor from sensing the torque value when a period from start of one print job to start of the torque sensing period is longer than a predetermined maximum period.

18. The image forming device of claim 17, further comprising
a maximum period setting unit that sets the maximum period based on a period from completion of a print job immediately preceding the one print job to start of warm-up for the one print job.

19. The image forming device of claim 16, further comprising:
an internal temperature sensor that senses an internal temperature of the image forming device; and
a prohibition unit that prohibits the torque sensor from sensing the torque value when the internal temperature of the image forming device falls out of a predetermined range.

20. The image forming device of claim 16, further comprising:
a pressure rotary member that comes into pressure-contact with the fixing rotary member such that the recording sheet is thermally fused and is pressed onto the recording sheet;
a pressure rotary member temperature sensor that senses a temperature of the pressure rotary member; and
a prohibition unit that prohibits the torque sensor from sensing the torque value when the temperature of the pressure rotary member falls out of a predetermined range.

21. The image forming device of claim 20, further comprising
an internal temperature sensor that senses an internal temperature of the image forming device, wherein
the prohibition unit prohibits the torque sensor from sensing the torque value when the temperature of the pressure rotary member falls out of a predetermined range relative to the internal temperature of the image forming device at start of a last warm-up before the torque sensing period.

22. The image forming device of claim 16, further comprising
a timing specification unit that specifies a torque sensing timing that is a timing when the fixing temperature coincides with a target temperature, wherein
the torque sensor senses the torque value at the specified torque sensing timing in the torque sensing period.

23. The image forming device of claim 1, wherein
the torque sensing period is a period in a test mode in which execution of a print job is interrupted, the driving speed is maintained constant, and the fixing temperature is maintained within the predetermined range.

24. The image forming device of claim 1, wherein
the prediction unit predicts a timing at which the torque value reaches a value corresponding to expiration of the operating life based on a timing at which the sensed torque value increases.
